(19) United States
(12) Patent Application Publication
(10) Pub. No.: US 2025/0305317 A1
(43) Pub. Date: Oct. 2, 2025

(54) SEISMIC ISOLATION DEVICE

(71) Applicants: Heung-Yeol KIM, Gunpo-si, Gyeonggi-do (KR); Hyun-Joo KIM, Gunpo-si, Gyeonggi-do (KR); Nicole Yoonjung KIM, New York, NY (US)

(72) Inventors: Heung-Yeol KIM, Gunpo-si, Gyeonggi-do (KR); Hyun-Joo KIM, Gunpo-si, Gyeonggi-do (KR); Nicole Yoonjung KIM, New York, NY (US)

(21) Appl. No.: 18/704,722

(22) PCT Filed: Sep. 19, 2022
(86) PCT No.: PCT/KR2022/013948

§ 371 Date: Oct. 10, 2024

(30) Foreign Application Priority Data
Oct. 27, 2021 (KR) 10-2021-0144652

(51) Int. Cl. E04H 9/02

(52) U.S. Cl. CPC E04H 9/023

(57) ABSTRACT

Proposed is a seismic isolation device. The seismic isolation device includes a sliding platform (100) and a sliding body (200) that is seated on an upper surface of the sliding platform (100). At least four sliding line grooves (122) are formed in the upper surface of the sliding platform (100). A sliding circle (222) having a ring shape is formed on a lower surface of the sliding body (200). A sliding ball (230) is accommodated simultaneously in the sliding line groove (122) and the sliding circle (222), and is configured such that the upper surface of the sliding platform (100) and the lower surface of the sliding body (200) are spaced apart from each other. The sliding platform (100) and the sliding body (200) are capable of being moved relative to each other in a horizontal direction by the sliding ball (230), thereby absorbing seismic vibration.

### TECHNICAL FIELD

The present disclosure relates to a seismic isolation device capable of absorbing vibrations so that a structure is protected from an earthquake.

### BACKGROUND ART

When an earthquake occurs, vibrations are transmitted longitudinally or transversely to a structure such as a building, and a transverse vibration causes the structure to be severely shaken. When the degree of vibration is severe, the stability of the structure is reduced by the vibrations causing partial damage to the structure, and in the worst situation, the structure may collapse. Accordingly, in order to prevent the structure from being damaged due to an earthquake, a seismic isolation device is mounted in the structure. Such a seismic isolation device maintains the structure in a normally supported state. Furthermore, when an earthquake occurs, the seismic isolation device absorbs vibrations caused by the earthquake, thereby protecting the structure from the earthquake.

### DISCLOSURE

### Technical Problem

Accordingly, the present disclosure has been made keeping in mind the above problems occurring in the related art, and an objective of the present disclosure is to provide a seismic isolation device capable of effectively absorbing vibrations applied to a structure in an earthquake situation, thereby being capable of safely protecting the structure.

### Technical Solution

In the present disclosure, there is provided a seismic isolation device including a sliding platform and a sliding body that is seated on an upper surface of the sliding platform. At least four sliding line grooves having a predetermined length from a center portion of the upper surface of the sliding platform toward an edge of the upper surface of the sliding platform are formed in the upper surface of the sliding platform and are disposed radially at an equal interval. A sliding circle having a predetermined diameter and having a ring shape is formed on a lower surface of the sliding body by forming a groove in the lower surface of the sliding body. A sliding ball is accommodated simultaneously in the sliding line groove and the sliding circle from between the sliding platform and the sliding body, and is configured such that the upper surface of the sliding platform and the lower surface of the sliding body are maintained in a state in which the upper surface of the sliding platform and the lower surface of the sliding body are spaced apart from each other by a predetermined distance. Therefore, the sliding platform and the sliding body are capable of being moved relative to each other in a horizontal direction by the sliding ball, thereby absorbing seismic vibration.

### Advantageous Effects

According to the present disclosure, in a situation in which an earthquake occurs, vibrations applied to a structure are capable of being effectively absorbed, so that the structure is capable of being safely protected when an earthquake occurs.

### DESCRIPTION OF DRAWINGS

FIG. 1 is an exemplary view illustrating a state in which a seismic isolation device is mounted on a structure,

FIG. 2 is an exemplary view illustrating a main configuration of the seismic isolation device according to the present disclosure,

FIG. 3 is an exploded perspective view illustrating the main configuration of the seismic isolation device according to the present disclosure,

FIG. 4 and FIG. 5 are exemplary views illustrating a relative movement of a sliding platform and a sliding body according to the present disclosure,

FIG. 6 is an exemplary view illustrating a state in which a plurality of sliding circles is formed in the seismic isolation device according to the present disclosure, and

FIG. 7 is an exemplary view illustrating a state in which an auxiliary sliding body is formed in the seismic isolation device according to the present disclosure.

### MODE FOR INVENTION

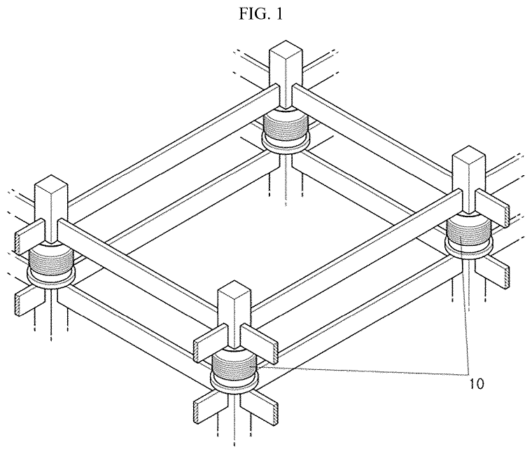

Hereinafter, the present disclosure will be described in detail with reference to FIG. 1 to FIG. 7.

FIG. 1 is an exemplary view illustrating a state in which a seismic isolation device is mounted on a structure.

As illustrated in the present disclosure, a seismic isolation device 10 is mounted for isolating a horizontal movement of a structure from the ground, and is mounted on a point of the structure at which the structure is capable of withstanding a load in a vertical direction. The seismic isolation device 10 may be mounted on a lower end portion of a pillar of the structure.

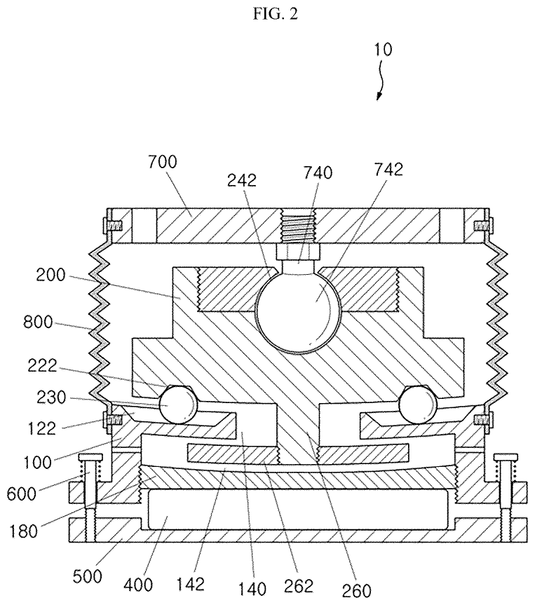

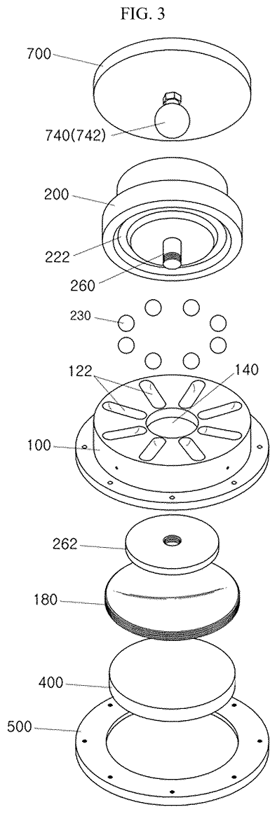

FIG. 2 is an exemplary view illustrating a main configuration of the seismic isolation device according to the present disclosure, and FIG. 3 is an exploded perspective view illustrating the main configuration of the seismic isolation device according to the present disclosure.

The seismic isolation device 10 according to the present disclosure includes a sliding platform 100, a sliding body 200, and a sliding ball 230 as main configurations.

The sliding platform 100 may be formed such that the sliding platform 100 has a predetermined thickness and an upper surface of the sliding platform 100 is formed in a downwardly concave spherical shape. The sliding platform 100 may be formed in a circular plate shape having a predetermined thickness, but is not limited thereto, and may be formed in a polygonal plate structure.

A groove is formed in the upper surface of the sliding platform 100 from a center portion of the upper surface to an edge of the upper surface, so that a sliding line groove 122 is formed. The sliding line groove 122 is formed such that the sliding line groove 122 has a predetermined length, a shape of the groove may be formed such that a cross-sectional shape of the groove has an arc shape or a trapezoidal shape, and the sliding line groove 122 may be formed up to a point close to the edge of the upper surface of the sliding platform 100. Such a sliding line groove 122 is formed such that a plurality of sliding line grooves 122 is radially disposed. The plurality of sliding line grooves 122 are disposed at an equal interval from each other, and preferably at least three sliding line grooves 122 are formed so that a balance of force is secured.

The sliding body 200 has a predetermined thickness and a predetermined area, and is seated on the upper surface of the sliding platform 100. Alower surface of the sliding body 200 is formed in a shape corresponding to the upper surface of the sliding platform 100. When the upper surface of the sliding platform 100 is formed in the downwardly concave spherical shape, the lower surface of the sliding body 200 is formed in a corresponding shape such that a convex spherical surface is formed.

A sliding circle 222 having a predetermined diameter is formed on the lower surface of the sliding body 200. The sliding circle 222 is formed as a circle centered at a center of the bottom surface of the sliding body 200, and is formed by forming a groove in the bottom surface of the sliding body 200.

A plurality of sliding circles 222 concentric with each other and having diameters different from each other may be formed. In addition, a shape of the groove forming the sliding circle 222 may be formed such that a cross-sectional shape of the groove has an arc shape, a trapezoidal shape, or the like.

As described above, the sliding line groove 122 formed on the upper surface of the sliding platform 100 and the sliding circle 222 formed on the lower surface of the sliding body 200 intersect each other when the sliding body 200 is seated on the upper surface of the sliding platform 100.

The sliding ball 230 is formed of a material having a high tensile strength and a high yield strength, such as metal and so on. Furthermore, the sliding ball 230 is mounted at a point where the sliding line groove 122 and the sliding circle 222 intersect each other. Accordingly, the sliding ball 230 is mounted such that the sliding ball 230 is accommodated in the sliding line groove 122 and the sliding circle 222 simultaneously. As a result, the sliding ball 230 mounted in the sliding line groove 122 supports the sliding body 200.

When the sliding ball 230 is mounted, the upper surface of the sliding platform 100 and the lower surface of the sliding body 200 maintain a state in which the upper surface of the sliding platform 100 and the lower surface of the sliding body 200 are spaced apart from each other by a predetermined distance. This is achieved by selecting a specification of the sliding ball 230. That is, the specification of the sliding ball 230 capable of maintaining the state in which the upper surface of the sliding platform 100 and the lower surface of the sliding body 200 are spaced apart from each other by the predetermined distance is selected.

Here, according to the number of sliding line grooves 122 and the number of sliding circles 222, the number of points at which the sliding line grooves 122 and the sliding circles 222 intersect each other is also different. For example, when the number of sliding line grooves 122 and the number of sliding circles 222 increase, the number of intersecting points also increases, and the number of mounted sliding balls 230 also increases naturally. As such, when the number of mounted sliding balls 230 increases, a load is dispersed, so that the ability to support the load is increased. Therefore, in consideration of this, the number of sliding line grooves 122 or sliding circles 222, and the number of sliding balls 230 are determined.

Meanwhile, in the present disclosure, a configuration that prevents the sliding body 200 from being separated from the upper surface of the sliding platform 100 may be adopted. This may be achieved by a movement restriction hole 140 formed in the center of the upper surface of the sliding platform 100 and a movement restriction protrusion 260 formed in the lower surface of the sliding body 200.

The movement restriction hole 140 is a hole having a predetermined depth and a predetermined diameter, and the movement restriction protrusion 260 is formed such that the movement restriction protrusion 260 has a thickness thinner than a diameter of the movement restriction hole 140. Therefore, the movement restriction protrusion 260 is capable of being moved by a predetermined amount within the movement restriction hole 140, but the movement restriction protrusion 260 does not deviate from the movement restriction hole 140 when a horizontal vibration occurs, so that the sliding body 200 does not separate from the upper surface of the sliding platform 100.

In the configuration as described above, a collapse-preventing means capable of preventing the sliding body 200 seated on the sliding platform 100 from falling may be provided.

The collapse-preventing means may include a collapse-preventing plate 262 having a plate shape and formed on a lower end of the movement restriction protrusion 260, and may include a collapse-preventing plate chamber 142 formed below the movement restriction hole 140. The collapse-preventing plate chamber 142 is formed such that the collapse-preventing plate chamber 142 has a free space so that the collapse-preventing plate 262 is capable of being moved, and is formed such that the collapse-preventing plate chamber 142 has a narrow entrance. Therefore, while the collapse-preventing plate 262 is capable of being moved within the collapse-preventing plate chamber 142, the collapse-preventing plate 262 does not deviate from the collapse-preventing plate chamber 142, so that the sliding body 200 is prevented from falling. In this configuration, the collapse-preventing plate chamber 142 is formed in the sliding platform 100. Therefore, since the sliding platform 100 is divided in half in a height direction based on the collapse-preventing plate chamber 142 and then is assembled, the collapse-preventing plate 262 is capable of being accommodated in the collapse-preventing plate chamber 142. For example, a structure in which the lower surface of the sliding platform 100 is formed as a coupling plate 180 configured to be detachably coupled and the coupling plate 180 forms a bottom of the collapse-preventing plate chamber 142 may be adopted. In this configuration, in a state in which the coupling plate 180 is separated from the sliding platform 100, the collapse-preventing plate 262 is introduced into the collapse-preventing plate chamber 142 from below the sliding platform 100, and then the collapse-preventing plate 262 is coupled to the movement restriction protrusion 260.

In addition to the basic configuration as described above, the seismic isolation device 10 according to the present disclosure has the sliding platform 100 and the sliding body 200 that are described above as the main configurations, and may further include some or all of an elastic cushion 400, a support 500, a structure support 700, and a protective cover 800.

The elastic cushion 400 is mounted below the sliding platform 100, and elastically supports the sliding platform 100. The elastic cushion 400 may be formed of a material having elasticity, for example, rubber or polyurethane. Furthermore, the elastic cushion 400 has a predetermined area and a predetermined thickness, and elastically absorbs a vertical vibration.

The support 500 is formed in a plate shape, and the elastic cushion 400 is seated on an upper surface of the support 500, thereby supporting the elastic cushion 400. A pan on which the elastic cushion 400 is seated is formed in the upper surface of the support 500, so that the support 500 is capable of restricting a movement of the elastic cushion 400 so that the elastic cushion 400 does not slip. The pan as described above may be similarly formed on the lower surface of the sliding platform 100, so that the elastic cushion 400 may be capable of being held from above and below.

Here, the support 500 is coupled to the sliding platform 100 by bolts 600 with the elastic cushion 400 interposed between the support 500 and the sliding platform 100. A plurality of bolts 600 is concentric with each other and is disposed to be spaced apart from each other by a predetermined distance, and couples the sliding platform 100 and the elastic cushion 400 to each other. At this time, the bolts 600 are fastened such that the bolts 600 are in a state in which the bolts 600 are capable of being moved in the vertical direction, and the bolts 600 are inserted into respective springs, so that the sliding platform 100 is capable of being moved in the vertical direction according to the contraction and expansion of the elastic cushion 400.

The structure support 700 is formed such that the structure support 700 is connected to an upper surface of the sliding body 200, and supports the structure. The structure support 700 has a predetermined thickness and is formed in a plate shape such that the structure is capable of being seated on an upper surface of the structure support 700. Furthermore, in the structure support 700, a pivot 740 having a lower end provided with a pivot ball 742 formed in a spherical shape protrudes downward, and the pivot 740 is coupled to a pivot ball cup 242 formed in the sliding body 200 such that the pivot 740 is capable of being rotated. Accordingly, the structure support 700 is seated on the sliding body 200 while being in a state in which the structure support 700 is capable of being rotated.

The protective cover 800 is a cover that is capable of being stretched, and a configuration in which a portion of the protective cover 800 is formed in a shape of a corrugated tube so that the protective cover 800 is capable of being stretched may be adopted. The protective cover 800 protects the sliding platform 100 and the sliding body 200 by accommodating the sliding platform 100 and the sliding body 200 therein. Furthermore, when vibrations occur, the protective cover 800 is naturally stretched, so that the protective cover 800 does not interfere with the seismic isolation device, according to the present disclosure, from absorbing vibrations.

When the elastic cushion 400, the support 500, and the structure support 700 are provided, a lower end of the protective cover 800 is fixed to the support 500 or the sliding platform 100, and an upper end of the protective cover 800 is fixed to the structure support 700, so that all or a part of the configurations are accommodated and protected. Blocked object may be dust, foreign substances, heat, flames, moisture, and so on. Therefore, by protecting the configurations from various external sources of contamination, the seismic isolation device according to the present disclosure may perform a function of the seismic isolation device in any environment and the service life of the seismic isolation device may be maximized.

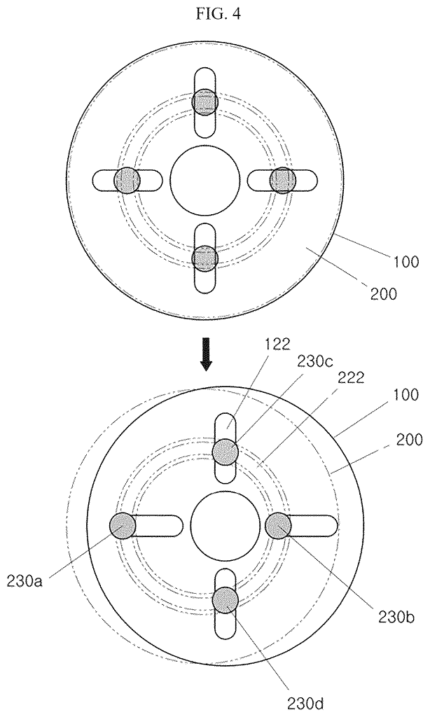

FIG. 4 and FIG. 5 are exemplary views illustrating a relative movement of the sliding platform and the sliding body according to the present disclosure.

In the configuration as described above, when the sliding body 200 is seated on the upper surface of the sliding platform 100, the sliding body 200 and the sliding platform 100 are free to move in a relative horizontal direction. This is due to the fact that the sliding body 200 and the sliding platform 100 are capable of being moved relative to each other along the sliding balls 230a, 230b, 230c, and 230d.

As illustrated in FIG. 4, when a force pushing the sliding platform 100 to a right side in the drawing is applied, the sliding body 200 is hardly moved and the sliding platform 100 is moved in the right side since the sliding body 200 is in a state in which the sliding body 200 is fixed to the structure. At this time, the sliding balls 230a and 230b accommodated in the sliding line grooves 122 formed in a straight line with a travel direction of the sliding platform 100 roll in place and allow the sliding platform 100 to be moved to the right side. Furthermore, sliding balls 230c and 230d accommodated in the sliding line grooves 122 crossing a direction of the force are moved to the center of the sliding platform 100 along the corresponding sliding line grooves 122 and the corresponding sliding circle 222.

As illustrated in FIG. 5, when a force is applied to push the sliding platform 100 diagonally in a direction different from the sliding line grooves 122, the sliding platform 100 is diagonally moved to the right side and the sliding body 200 is not moved since the sliding body 200 is in the state in which the sliding body 200 is fixed to the structure. At this time, the sliding balls 230 are moved along the sliding line grooves 122 and the sliding circle 222 so that the sliding platform 100 is capable of being moved diagonally.

According to the configuration described above, in a state in which the sliding body 200 supports the structure, even when seismic vibrations occur and a force is applied to the sliding platform 100 in any direction such as the horizontal direction or a torsional direction, transmission of the movement of the sliding platform 100 to the sliding body 200 is capable of being reduced. As a result, the degree to which the seismic vibrations is transmitted to the structure supported by the sliding body 200 is capable of being reduced.

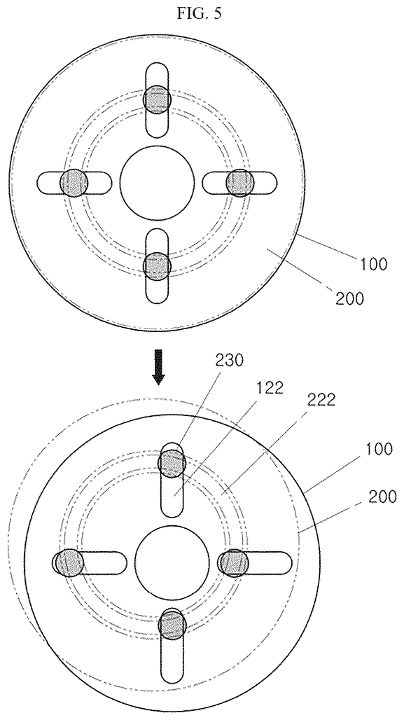

FIG. 6 is an exemplary view illustrating a state in which the plurality of sliding circles is formed in the seismic isolation device according to the present disclosure.

Previously, it has been described that the sliding line groove 122 formed in the sliding platform 100 may be provided with the plurality of sliding line grooves 122 and the sliding circle 222 formed in the sliding body 200 may be provided with the plurality of sliding circles 222, a structure in which two sliding circles 222 are formed is illustrated in FIG. 6. In this case, two sliding balls 230 are accommodated for each sliding line groove 122.

Meanwhile, it is illustrated in FIG. 6 that cross-sectional surfaces of the grooves forming the sliding circles 222 have arc shapes.

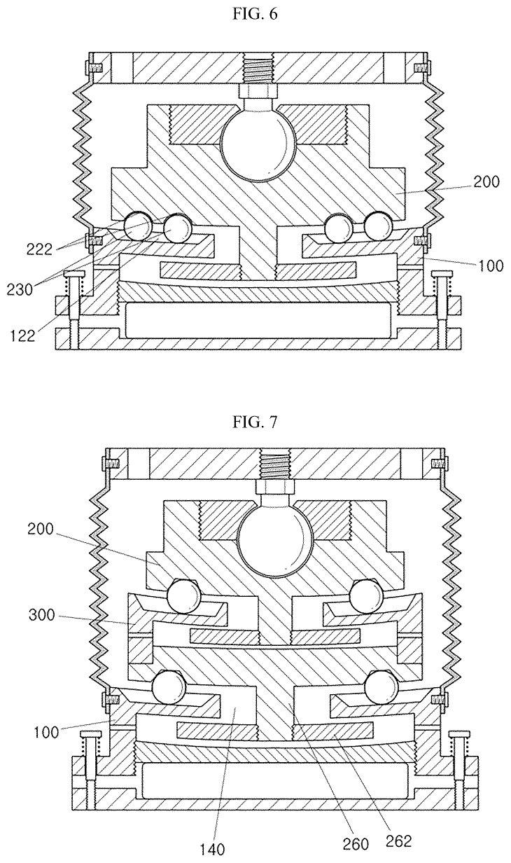

FIG. 7 is an exemplary view illustrating a state in which an auxiliary sliding body is formed in the seismic isolation device according to the present disclosure.

In the seismic isolation device according to the present disclosure, an auxiliary sliding body 300 may be formed between the sliding platform 100 and the sliding body 200.

The auxiliary sliding body 300 has a predetermined thickness and is formed in a circular plate structure or a polygonal plate structure, and a structure of an upper surface of the auxiliary sliding body 300 is the same as the structure of the upper surface of the sliding platform 100. In addition, a structure of a lower surface of the auxiliary sliding body 300 is the same as the structure of the lower surface of the sliding body 200. Therefore, between the sliding platform 100 and the sliding body 200, the auxiliary sliding body 300 is seated on the sliding platform 100 by being supported by the sliding ball 230 seated on the sliding platform 100, and the sliding body 200 supported by the sliding ball 230 is seated on the auxiliary sliding body 300. Through this, the seismic isolation device in which the auxiliary sliding body 300 and the sliding body 200 form a multi-stage structure is formed is provided.

In this configuration, configurations same as the movement restriction hole 140, the movement restriction protrusion 260, and the collapse-preventing plate 262 formed on the sliding platform 100 and the sliding body 200 may be formed on the auxiliary sliding body 300, and functions of the configurations are the same.

### SEQUENCE LISTING FREE TEXT

### Description of Reference Numerals

10: seismic isolation device,
100: sliding platform, 122: sliding line groove,
140: movement restriction hole, 142: collapse-preventing plate chamber
180: coupling plate,
200: sliding body, 222: sliding circle,
230: sliding ball, 242: pivot ball cup,
260: movement restriction protrusion, 262: collapse-preventing plate
300: auxiliary sliding body, 400: elastic cushion,
500: support, 600: bolts,
700: structure support, 740: pivot,
742: pivot ball,
800: protective cover.

1. A seismic isolation device comprising:
a sliding platform (100); and
a sliding body (200) seated on an upper surface of the sliding platform (100),
wherein a sliding line groove (122) is formed such that at least four sliding line grooves (122) formed by forming grooves having a predetermined length from a center portion of the upper surface of the sliding platform (100) toward an edge of the upper surface of the sliding platform (100) are formed in the upper surface of the sliding platform (100) and are disposed radially at an equal interval,
a sliding circle (222) having a predetermined diameter and having a ring shape is formed on a lower surface of the sliding body (200) by forming a groove in the lower surface of the sliding body (200), and
a sliding ball (230) is accommodated simultaneously in the sliding line groove (122) and the sliding circle (222) from between the sliding platform (100) and the sliding body (200), and is configured such that the upper surface of the sliding platform (100) and the lower surface of the sliding body (200) are maintained in a state in which the upper surface of the sliding platform (100) and the lower surface of the sliding body (200) are spaced apart from each other by a predetermined distance, so that
the sliding platform (100) and the sliding body (200) are capable of being moved relative to each other in a horizontal direction by the sliding ball (230), thereby absorbing seismic vibration.

2. The seismic isolation device of claim 1, wherein the upper surface of the sliding platform (100) has a downwardly concave spherical shape, and the lower surface of the sliding body (200) has a downwardly convex spherical shape such that the lower surface of the sliding body (200) corresponds to the upper surface of the sliding platform (100).

3. The seismic isolation device of claim 1, wherein the sliding circle (222) comprises a plurality of sliding circles (222) concentric with each other and having diameters different from each other.

4. The seismic isolation device of claim 1, wherein a movement restriction hole (140) is formed at a center of the upper surface of the sliding platform (100) and a movement restriction protrusion (260) corresponding to the movement restriction hole (140) is formed on the lower surface of the sliding body (200),
a collapse-preventing plate chamber (142) having a narrow entrance is formed below the movement restriction hole (140), and
a collapse-preventing plate (262) is formed on a lower end of the movement restriction protrusion (260) and the movement restriction protrusion (260) is accommodated in the collapse-preventing plate chamber (142), so that
the movement restriction protrusion (260) does not deviate from the movement restriction hole (140) and the sliding body (200) does not separate from the sliding platform (100).
